(19) United States
(12) Patent Application Publication
(10) Pub. No.: US 2025/0364923 A1
(43) Pub. Date: Nov. 27, 2025

(54) POWER CONVERSION DEVICE AND ESTIMATION METHOD FOR DIRECT CURRENT IN POWER CONVERSION DEVICE

(71) Applicant: HITACHI ASTEMO, LTD., Hitachinaka-shi, Ibaraki (JP)

(72) Inventors: Ryutaro NAKAZATO, Hitachinaka-shi (JP); Shinichirou HIDA, Hitachinaka-shi (JP); Ryoichi INADA, Tokyo (JP)

(73) Assignee: HITACHI ASTEMO, LTD., Hitachinaka-shi, Ibaraki (JP)

(21) Appl. No.: 18/873,196

(22) PCT Filed: Jun. 21, 2022
(86) PCT No.: PCT/JP2022/024779

§ 371 Date: Dec. 9, 2024

(51) Int. Cl. H02M 7/539; H02M 1/088

(52) U.S. Cl. CPC H02M 7/539; H02M 1/088

(57) ABSTRACT

A power conversion device that includes: switching elements of upper and lower arms connected in series between a positive-side terminal and a negative-side terminal of direct current; an alternating current detection unit that detects an alternating current derived from a connection point between the switching element of the upper arm and the switching element of the lower arm; a switch element inter-terminal voltage detection unit that detects an inter-terminal voltage of any switching element of the switching elements of the upper arm and the lower arm, and/or a mirror current detection unit that detects a mirror current flowing through a mirror element connected in parallel to each of the switching elements; and a direct current estimation unit that estimates a direct current flowing between the positive-side terminal and the negative-side terminal based on the inter-terminal voltage and/or the mirror current and the alternating current.

### TECHNICAL FIELD

The present invention relates to a power conversion device and an estimation method for direct current in the power conversion device.

### BACKGROUND ART

The power conversion device controls on/off of a switching element, converts a direct current supplied from a direct current power source into an alternating current, and drives a motor. The power conversion device includes a direct current sensor for detecting a direct current input to the power conversion device.

PTL 1 discloses a current detection device including a power MOSFET which is connected between an electric load and a power supply and controls a current flowing to the electric load, and a Miller MOSFET which is connected to the power MOSFET in parallel therewith and to which part of the current flowing to the power MOSFET flows, a current detection resistor which is connected between a source electrode of the power MOSFET and a source electrode of the Miller MOSFET, and a conversion means that converts voltages in positive and negative directions generated at both ends of this current detection resistor to a positive or negative voltage.

### CITATION LIST

### Patent Literature

PTL 1: JP 2004-201427 A

### SUMMARY OF INVENTION

### Technical Problem

For the device described in PTL 1, detection of direct current is not considered, and a direct current sensor is necessary.

### Solution to Problem

A power conversion device according to the present invention includes: a switching element of an upper arm and a switching element of a lower arm connected in series between a positive-side terminal and a negative-side terminal of direct current; an alternating current detection unit that detects an alternating current derived from a connection point between the switching element of the upper arm and the switching element of the lower arm; a switch element inter-terminal voltage detection unit that detects an inter-terminal voltage of any switching element of the switching elements of the upper arm and the lower arm, and/or a mirror current detection unit that detects a mirror current flowing through a mirror element connected in parallel to each of the switching elements; and a direct current estimation unit that estimates a direct current flowing between the positive-side terminal and the negative-side terminal based on the inter-terminal voltage and/or the mirror current and the alternating current.

An estimation method for direct current in a power conversion device according to the present invention is an estimation method for direct current in a power conversion device including a switching element of an upper arm and a switching element of a lower arm connected in series between a positive-side terminal and a negative-side terminal of direct current, an alternating current detection unit that detects an alternating current derived from a connection point between the switching element of the upper arm and the switching element of the lower arm, and at least one of a collector-emitter voltage detection unit between a collector and an emitter of the switching element, a gate-emitter voltage detection unit between a gate and an emitter of the switching element, and/or a mirror current detection unit that detects a mirror current flowing through a mirror element connected in parallel to each of the switching elements, the estimation method for direct current in a power conversion device, in which a direct current flowing between the positive-side terminal and the negative-side terminal is estimated based on an ON time of at least one of the collector-emitter voltage, the gate-emitter voltage, and the mirror current, and the alternating current.

### Advantageous Effects of Invention

According to the present invention, it is possible to eliminate the need for a direct current sensor, and accurately estimate a direct current.

### BRIEF DESCRIPTION OF DRAWINGS

FIG. 1 is a circuit configuration diagram of a power conversion device according to an embodiment of the present invention.

FIGS. 2 (A) and (B) are waveform diagrams illustrating a Vce voltage and an ON time of a power module of an upper arm.

FIGS. 3 (A) and (B) are waveform diagrams illustrating a Vge voltage and an ON time of a power module of an upper arm.

FIGS. 4 (A), (B), (C), and (D) are waveform diagrams illustrating mirror currents and ON times.

FIG. 5 is a detailed view of a direct current estimation unit.

FIG. 6 is a table showing a relationship between an operation mode and estimation of direct current.

FIG. 7 is a table showing priority of operation terms of each phase.

FIG. 8 is a flowchart showing an operation of estimation processing of direct current in the direct current determination circuit.

FIG. 9 a to h are tables showing priorities including disabled mirror current operation terms in a U-phase, a V-phase, and a W-phase.

FIGS. 10 (A), (B), and (C) are views illustrating waveforms of alternating currents of the U-phase, the V-phase, and the W-phase.

### DESCRIPTION OF EMBODIMENTS

Hereinafter, an embodiment of the present invention will be described with reference to the drawings. The following description and drawings are examples for explaining the present invention, and are omitted and simplified as appropriate for the sake of clarity of description. The present invention can be carried out in various other forms. Unless otherwise specified, each constituent element may be singular or plural.

The positions, sizes, shapes, ranges, and the like of the constituent elements illustrated in the drawings do not always represent actual positions, sizes, shapes, ranges, and the like, for the sake of easy understanding of the invention. Therefore, the present invention is not necessarily limited to the position, size, shape, range, and the like disclosed in the drawings.

### EMBODIMENT

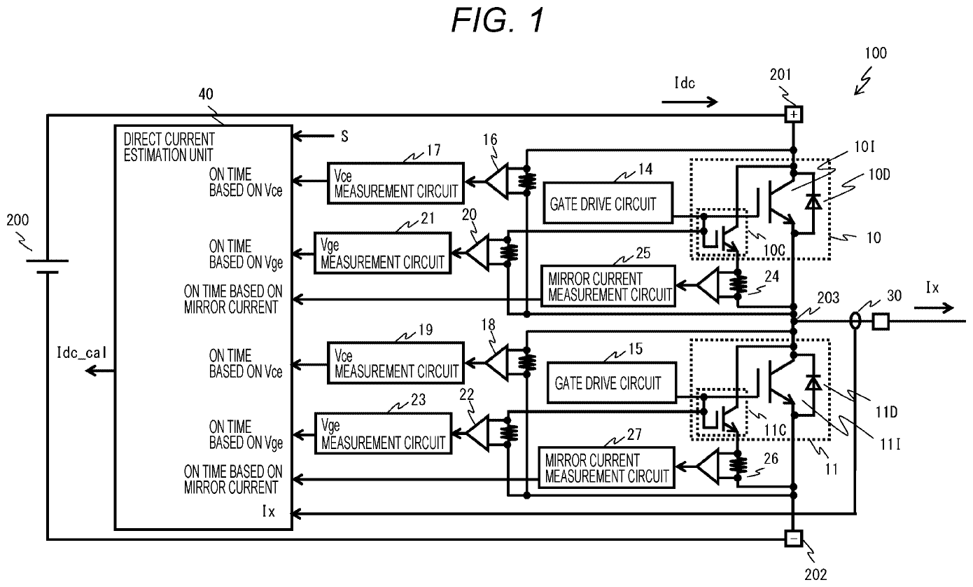

FIG. 1 is a circuit configuration diagram of a power conversion device 100 according to an embodiment of the present invention.

The power conversion device 100 converts a direct current supplied from a direct current power source 200 into an alternating current, supplies the alternating current to a winding of a motor not illustrated, and drives the motor. The direct current power source 200 is, for example, a chargeable/dischargeable battery.

A power module 10 of the upper arm and a power module 11 of the lower arm are connected in series between a positive-side terminal 201 and a negative-side terminal 202 of direct current connected to the direct current power source 200 to constitute a conversion unit for one phase. Although not illustrated, the power conversion device 100 is configured by a three-phase bridge circuit in which the conversion units for one phase are connected in parallel to form three phases. An alternating current Ix is derived to the winding of the motor from an intermediate connection point 203 between the power module 10 of the upper arm and the power module 11 of the lower arm of each phase. The alternating current Ix is a generic term for an alternating current Iu of the U-phase, an alternating current Iv of the V-phase, and an alternating current Iw of the W-phase. Note that the power conversion device 100 is supplied with a direct current Idc from the direct current power source 200, but in the present embodiment, the value of this direct current Idc is estimated without using a direct current sensor. The estimated direct current is called Idc_cal.

The power module 10 of the upper arm connects a switching element 10I and a diode 10D in antiparallel and includes a current mirror circuit 10C. The current mirror circuit 10C includes a mirror element, and a collector of the mirror element is connected to a collector of the switching element 10I, a base of the mirror element is connected to a base of the switching element 10I, and an emitter of the mirror element is connected to an emitter of the switching element 10I via a mirror current detector 24. The switching element 10I is an IGBT, for example. The current mirror circuit 10C is used for short circuit detection of the switching element 10I. The mirror current is a mirror of the current flowing through the switching element 10I, and has a value of about 1/1000 to 1/10000 with respect to the collector current. The power module 11 of the lower arm has a similar configuration, connects a switching element 11I and a diode 11D in antiparallel, and includes a current mirror circuit 11C.

PWM signals are input from gate drive circuits 14 and 15 to gates of the switching element 10I and the switching element 11I, respectively, and ON/OFF of the switching element 10I and the switching element 11I are controlled by the PWM signals. Note that although a control device that generates the PWM signals is not illustrated, the control device includes a microcomputer, and generates the PWM signal in a normal PWM mode with reference to the motor rotation speed, the alternating current Ix, the direct current Idc_cal, and the like in response to a torque command from a higher order control device. The control device designates an operation mode of each of the switching elements 10I and 11I of the upper arm and the lower arm, and the operation mode includes a PWM mode, a one-side three-phase short-circuit mode, and three-phase open mode, whose details will be described later. In addition to the operation mode, the control device outputs a failure state and priority described later. These are called information S of an operation mode and the like.

A Vce (collector-emitter voltage) detector 16 is provided between the collector and the emitter of the switching element 10I of the upper arm, and detects the Vce voltage. The detected Vce voltage is input to a Vce measurement circuit 17. The Vce measurement circuit 17 has appropriate thresholds set for rise and fall of the Vce voltage, and detects whether the Vce voltage has changed beyond the threshold, that is, an edge of the Vce voltage. Then, an interval between a rising edge and a falling edge of the detected Vce voltage, that is, the ON time based on a rectangular wave of the Vce voltage indicating ON/OFF of the switching element 10I is measured and output to a direct current estimation unit 40 as an ON time of the upper arm based on the Vce voltage.

A Vce (collector-emitter voltage) detector 18 is provided between the collector and the emitter of the switching element 11I of the lower arm, and detects the Vce voltage. The detected Vce voltage is input to a Vce measurement circuit 19. The Vce measurement circuit 19 has appropriate thresholds set for rise and fall of the Vce voltage, and detects whether the Vce voltage has changed beyond the threshold, that is, an edge of the Vce voltage. Then, an interval between a rising edge and a falling edge of the detected Vce voltage, that is, the ON time based on a rectangular wave of the Vce voltage indicating ON/OFF of the switching element 11I is measured and output to the direct current estimation unit 40 as an ON time of the lower arm based on the Vce voltage.

A Vge (gate-emitter voltage) detector 20 is provided between the gate and the emitter of the switching element 10I of the upper arm, and detects the Vge voltage. The detected Vge voltage is input to a Vge measurement circuit 21. The Vge measurement circuit 21 has appropriate thresholds set for rise and fall of the Vge voltage, and detects whether the Vge voltage has changed beyond the threshold, that is, an edge of the Vge voltage. Then, an interval between a rising edge and a falling edge of the detected Vge voltage, that is, the ON time based on a rectangular wave of the Vge voltage indicating ON/OFF of the switching element 10I is measured and output to the direct current estimation unit 40 as an ON time of the upper arm based on the Vge voltage.

A Vge (gate-emitter voltage) detector 22 is provided between the gate and the emitter of the switching element 11I of the lower arm, and detects the Vge voltage. The detected Vge voltage is input to a Vge measurement circuit 23. The Vge measurement circuit 23 has appropriate thresholds set for rise and fall of the Vge voltage, and detects whether the Vge voltage has changed beyond the threshold, that is, an edge of the Vge voltage. Then, an interval between a rising edge and a falling edge of the detected Vge voltage, that is, the ON time based on a rectangular wave of the Vge voltage indicating ON/OFF of the switching element 11I is measured and output to the direct current estimation unit 40 as an ON time of the lower arm based on the Vge voltage.

The mirror current detector 24 of the upper arm is connected between the current mirror circuit 10C and the emitter of the switching element 10I, and detects a mirror current flowing through the mirror element. The detected mirror current is input to a mirror current measurement circuit 25. The mirror current measurement circuit 25 has appropriate thresholds set for rising and falling of the mirror current, and detects whether the mirror current has changed beyond the threshold, that is, an edge of the mirror current. Then, an interval between a rising edge and a falling edge of the detected mirror current, that is, the ON time based on a rectangular wave of the mirror current indicating ON/OFF of the switching element 10I is measured and output to the direct current estimation unit 40 as an ON time of the upper arm based on the mirror current.

The mirror current detector 26 of the lower arm is connected between the current mirror circuit 11C and the emitter of the switching element 11I, and detects a mirror current flowing through the mirror element. The detected mirror current is input to a mirror current measurement circuit 27. The mirror current measurement circuit 27 has appropriate thresholds set for rising and falling of the mirror current, and detects whether the mirror current has changed beyond the threshold, that is, an edge of the mirror current. Then, an interval between a rising edge and a falling edge of the detected mirror current, that is, the ON time based on a rectangular wave of the mirror current indicating ON/OFF of the switching element 11I is measured and output to the direct current estimation unit 40 as an ON time of the lower arm based on the mirror current.

As already mentioned, FIG. 1 illustrates the conversion unit for one phase in which the power module 10 of the upper arm and the power module 11 of the lower arm are connected in series. The conversion unit for one phase is provided with the Vce detectors 16 and 18, the Vce measurement circuits 17 and 19, the Vge detectors 20 and 22, the Vge measurement circuits 21 and 23, the mirror current detectors 24 and 26, and the mirror current measurement circuits 25 and 27. These circuits are similarly provided corresponding to the other two phases not illustrated. The ON times obtained by the Vce measurement circuits 17 and 19, the Vge measurement circuits 21 and 23, and the mirror current measurement circuits 25 and 27 are output to the direct current estimation unit 40. An alternating current sensor 30 is provided on wiring of each phase derived to the winding of the motor from the intermediate connection point 203 between the power module 10 of the upper arm and the power module 11 of the lower arm of each phase. The alternating current Ix of each phase detected by the alternating current sensor 30 is output to the direct current estimation unit 40.

The direct current estimation unit 40 estimates the direct current based on the ON time of each phase input from each of the measurement circuits 17, 19, 21, 23, 25, and 27, the alternating current Ix of each phase, the information S such as the operation mode, and the like, and outputs the estimated direct current Idc_cal.

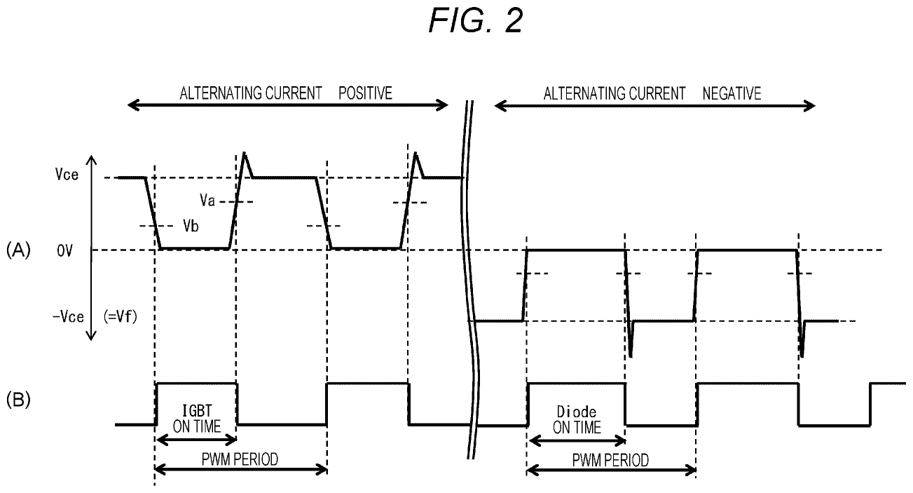

FIGS. 2(A) and 2(B) are waveform diagrams illustrating the Vce voltage and the ON time of the power module 10 of the upper arm. FIG. 2(A) illustrates the Vce voltage of the power module 10 of the upper arm, and FIG. 2(B) illustrates the ON time of the power module 10 of the upper arm. The orientation of the alternating current flowing into the motor is positive, and the opposite orientation is negative, and in each drawing, the left side indicates a case where the alternating current is positive, and the right side indicates a case where the alternating current is negative. These waveform diagrams illustrate one phase. FIG. 2(A) is a waveform detected by the Vce detector 16, and FIG. 2(B) is an ON time output from the Vce measurement circuit 17.

As illustrated in FIG. 2(A), the switching element 10I of the upper arm is turned ON/OFF by the PWM signal. In a case where the alternating current is negative, a voltage Vf of the diode 10D is measured as the Vce voltage of the power module 10. The Vce measurement circuit 17 detects the edge of the Vce voltage that changes beyond thresholds Va and Vb at the rise and fall of the Vce voltage, and detects the ON state of the switching element 10I. Since the edge of the Vce voltage is detected, it is not necessary to consider the gain accuracy of the physical quantity of the element as compared with a case of using an analog value. In a case where the alternating current is positive, as illustrated in FIG. 2(B), the time during which the switching element 10I is in the ON state, that is, the Vce voltage is in a state of being 0 V is output as the ON time of the upper arm based on the Vce voltage. In the case where the alternating current is negative, the time during which the switching element 10I is in the ON state, that is, the voltage Vf of the diode 10D is in a state of being 0 V is output as the ON time of the upper arm based on the Vce voltage. In FIG. 2 (B), the ON time of the upper arm when the alternating current is positive is represented by “IGBT ON TIME”, and the ON time of the upper arm when the alternating current is negative is represented by “Diode ON TIME”.

Since the Vce detector 16 measures the voltages at both ends of the switching element 10I and the diode 10D connected in antiparallel, the Vce measurement circuit 17 can measure the ON time of the power module 10 of the upper arm regardless of the orientation of the alternating current.

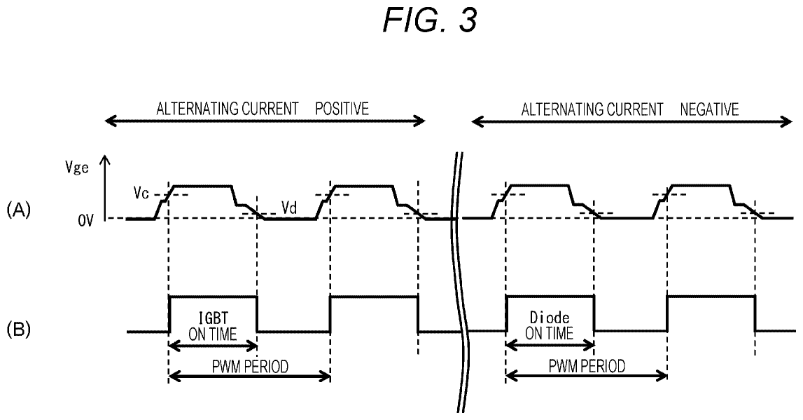

FIGS. 3(A) and 3(B) are waveform diagrams illustrating the Vge voltage and the ON time of the power module 10 of the upper arm. FIG. 3(A) illustrates the Vge voltage of the power module 10 of the upper arm, and FIG. 3(B) illustrates the ON time of the power module 10 of the upper arm. In each drawing, the left side indicates a case where the alternating current is positive, and the right side indicates a case where the alternating current is negative. These waveform diagrams illustrate one phase. FIG. 3(A) is a waveform detected by the Vge detector 20, and FIG. 3(B) is an ON time output from the Vge measurement circuit 21.

As illustrated in FIG. 3(A), regardless of positive or negative of the alternating current, the switching element 10I of the upper arm is turned ON/OFF by the PWM signal. The Vge voltage is a drive voltage applied between the gate and the emitter of the switching element 10I by the PWM signal. The Vge measurement circuit 21 detects the edge of the Vge voltage that changes beyond thresholds Vc and Vd at the rise and fall of the Vge voltage, and detects the ON state of the switching element 10I. Since the edge of the Vge voltage is detected, it is not necessary to consider the gain accuracy of the physical quantity of the element as compared with a case of using an analog value. Then, as illustrated in FIG. 3(B), the time during which the switching element 10I is in the ON state, that is, the Vge voltage is in a state of being applied is output as the ON time of the upper arm based on the Vge voltage. In FIG. 3(B), the ON time of the upper arm when the alternating current is positive is represented by “IGBT ON TIME”, and the ON time of the upper arm when the alternating current is negative is represented by “Diode ON TIME”.

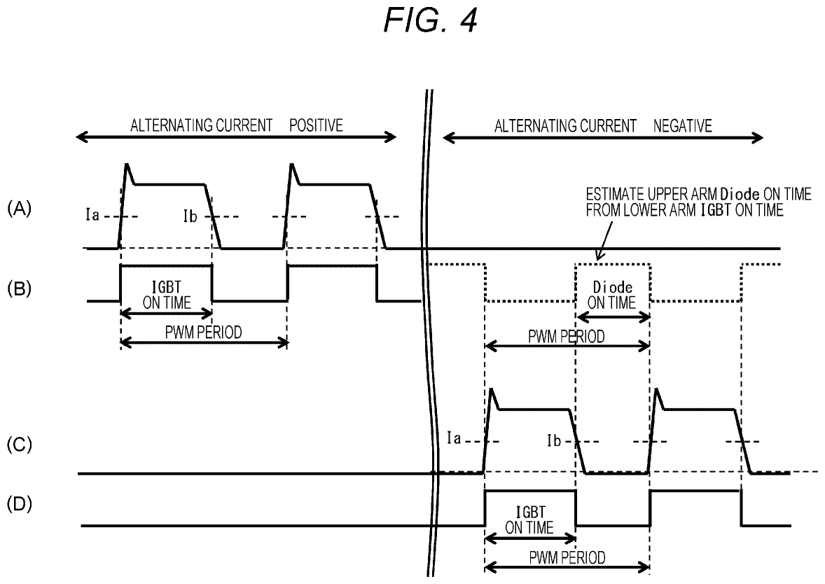

FIGS. 4(A), 4(B), 4(C), and 4(D) are waveform diagrams illustrating the mirror currents and the ON times. FIG. 4(A) illustrates the mirror current of the switching element 10I of the upper arm, FIG. 4(B) illustrates the ON time of the switching element 10I of the upper arm, FIG. 4(C) illustrates the mirror current of the switching element 11I of the lower arm, and FIG. 4(D) illustrates the ON time of the switching element 11I of the lower arm. In each drawing, the left side indicates a case where the alternating current is positive, and the right side indicates a case where the alternating current is negative. These waveform diagrams illustrate one phase. FIG. 4(A) is a waveform detected by the mirror current detector 24, and FIG. 4(B) is an ON time output from the mirror current measurement circuit 25. FIG. 4(C) is a waveform detected by the mirror current detector 26, and FIG. 4(D) is an ON time output from the mirror current measurement circuit 27. Note that the mirror current detectors 24 and 26 detect mirror currents of the switching elements 10I and 11I, and do not detect currents of the diodes 10D and 11D. However, in the case where the alternating current is negative, as illustrated in FIG. 4 (B), the ON time of the diode 10D of the upper arm can be estimated by the ON time of the switching element 11I of the lower arm.

As illustrated in FIG. 4 (A), in the case where the alternating current is positive, when the switching element 10I of the upper arm is turned ON/OFF by the PWM signal, the mirror current of the upper arm changes accordingly. On the other hand, as illustrated in FIG. 4(C), even when the switching element 11I of the lower arm is turned ON/OFF, the mirror current of the lower arm does not change. In the case where the alternating current is negative, when the switching element 11I of the lower arm is turned ON/OFF by the PWM signal, the mirror current of the lower arm changes accordingly. On the other hand, as illustrated in FIG. 4(A), even when the switching element 10I of the upper arm is turned ON/OFF, the mirror current of the upper arm does not change. The mirror current measurement circuits 25 and 27 detect the edges of the mirror currents that change beyond thresholds Ia and Ib at the rise and fall of the mirror currents, and detect the ON state of the switching element 10I. Since the edge of the mirror current is detected, it is not necessary to consider the gain accuracy of the physical quantity of the element as compared with a case of using an analog value.

As illustrated in FIGS. 4(B) and 4(D), the time during which the switching elements 10I and 11I are in the ON state, that is, the mirror current is in a state of flowing is output as the ON times of the upper arm and the lower arm, respectively, based on the mirror current. In a case of calculating the ON time of the upper arm, in the case where the alternating current is positive, the ON time of the switching element 10I of the upper arm is measured with the mirror current of the upper arm, and the ON time of the upper arm is calculated from the measured ON time of the switching element 10I of the upper arm. In the case where the alternating current is negative, the ON time of the switching element 11I of the lower arm is measured with the mirror current of the lower arm, and the ON time of the upper arm is estimated from the measured ON time of the switching element 11I of the lower arm. In FIG. 4(B), the ON time of the upper arm when the alternating current is positive is represented by “IGBT ON TIME”, and the ON time of the upper arm when the alternating current is negative is represented by “Diode ON TIME”. In a case of calculating the ON time of the lower arm, in the case where the alternating current is positive, the ON time of the switching element 10I of the upper arm is measured with the mirror current of the upper arm, and the ON time of the lower arm is estimated from the measured ON time of the switching element 10I of the upper arm. In the case where the alternating current is negative, the ON time of the switching element 11I of the lower arm is measured with the mirror current of the lower arm, and the ON time of the lower arm is calculated from the measured ON time of the switching element 11I of the lower arm. Although not illustrated in FIG. 4, the ON time of the lower arm when the alternating current is positive is “Diode ON TIME”, and the ON time of the lower arm when the alternating current is negative is “IGBT ON TIME”.

Note that it is difficult for the direct current estimation unit 40 to set the thresholds Ia and Ib when the alternating current is small. In the direct current estimation unit 40, a mirror current disabled range is preset corresponding to the magnitude of the alternating current in accordance with the characteristics of the switching elements 10I and 11I, and if the alternating current is in this mirror current disabled range, the measurement result of the ON time based on the mirror current is not used.

Note that since the mirror current is a mirror of the collector current of the switching elements 10I and 11I, the current value fluctuates as the alternating current. For example, the thresholds Ia and Ib are desirably set in the range of the following Expressions (1) and (2).

$$Threshold Ia , Ib + α < \vert Upper limit of mirror current disabled range \vert * Scale ratio \qquad ( 1 )$$

$$Threshold Ia , Ib + α > \vert Lower limit of mirror current disabled range \vert * Scale ratio \qquad ( 2 )$$

Here, α is a margin, the scale ratio is an alternating current/mirror current, and |Lower limit of mirror current disabled range| is a small value.

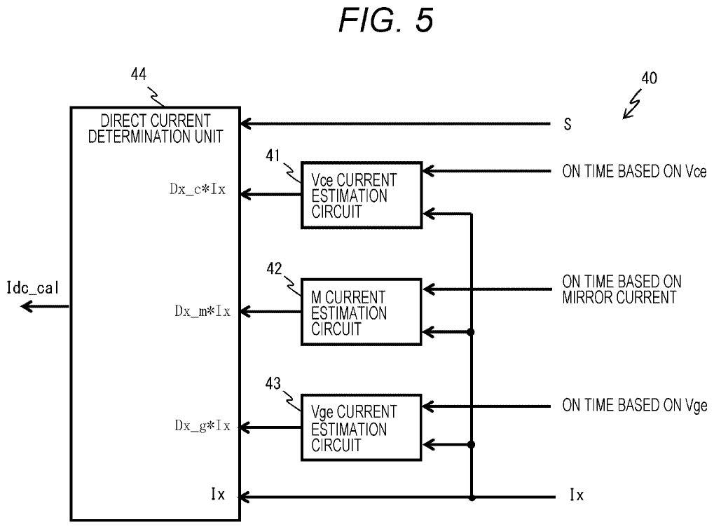

FIG. 5 is a detailed diagram of the direct current estimation unit 40.

The direct current estimation unit 40 includes a Vce current estimation circuit 41, an M current estimation circuit 42, a Vge current estimation circuit 43, and a direct current determination circuit 44. The ON times of respective phases are input to the Vce current estimation circuit 41, the M current estimation circuit 42, and the Vge current estimation circuit 43, and the alternating current Ix of each phase is further input thereto.

Here, the estimated direct current Idc_cal is obtained by the following Expression (3).

$$Idc\_cal = Du * Iu + Dv * Iv + Dw * Iw \qquad ( 3 )$$

Du, Dv, and Dw are duties of the U-phase, the V-phase, and the W-phase, and are calculated in the Vce current estimation circuit 41, the M current estimation circuit 42, and the Vge current estimation circuit 43 based on the ON times and PWM periods of the respective phases. Iu, Iv, and Iw are alternating currents of the respective phases. In the estimation of the direct current Idc_cal, since the estimation may be performed with either the current flowing into each phase or the current flowing out, either the ON time of the upper arm or the ON time of the lower arm is used. Although FIG. 1 illustrates a configuration in which both the ON time of the upper arm and the ON time of the lower arm are measured, a configuration in which either one is measured may be adopted.

The Vce current estimation circuit 41 calculates duties Du_c, Dv_c, and Dv_c of the respective phases based on the ON times of the respective phases from the Vce measurement circuits 17 and 19. The duty of each phase is collectively called Dx_c. The duty Dx_c of each phase is calculated by Dx_c=ON time/PWM period. Then, the operation term of each phase represented by Expression (3) is calculated. Specifically, the operation terms of the respective phases are calculated by expressions of Du_c*Iu, Dv_c*Iv, and Dv_c*Iw. The operation term of each phase is collectively called Dx_c*Ix. The Vce current estimation circuit 41 outputs the operation term Dx_c*Ix of each phase calculated as described above.

The M current estimation circuit 42 calculates duties Du_m, Dv_m, and Dv_m of the respective phases based on the ON time of the respective phases from the mirror current measurement circuits 25 and 27. The duty of each phase is collectively called Dx_m. The duty Dx_m of each phase is calculated by Dx_m=(ON time of upper arm)/PWM period, when the alternating current Ix>0 amperes (0 A). When the alternating current Ix<0 amperes (0 A), it is calculated by Dx_m=(PWM period−(ON time of lower arm))/PWM period. Then, the operation term of each phase represented by Expression (3) is calculated. The operation terms of the respective phases are calculated by respective expression of Du_m*Iu, Dv_m*Iv, and Dv_m*Iw. The operation term of each phase is collectively called Dx_m*Ix. The M current estimation circuit 42 outputs the operation term Dx_m*Ix of each phase calculated as described above.

The Vge current estimation circuit 43 calculates duties Du_g, Dv_g, and Dv_g of the respective phases based on the ON time of the respective phases from the Vce measurement circuits 17 and 19. The duty of each phase is collectively called Dx_g. The duty Dx_g of each phase is calculated by Dx_g=ON time/PWM period. Then, the operation term of each phase represented by Expression (3) is calculated. The operation terms of the respective phases are calculated by respective expression of Du_g*Iu, Dv_g*Iv, and Dv_g*Iw. The operation term of each phase is collectively called Dx_g*Ix. The Vge current estimation circuit 43 outputs the operation term Dx_g*Ix of each phase calculated as described above.

To the direct current determination circuit 44, the operation terms Dx_c*Ix, Dx_m*Ix, and Dx_g*Ix from the Vce current estimation circuit 41, the M current estimation circuit 42, and the Vge current estimation circuit 43, respectively, are input. The information S such as the operation mode is further input to the direct current determination circuit 44 from the control device not illustrated. The direct current determination circuit 44 selects the operation terms Dx_c*Ix, Dx_m*Ix, and Dx_g*Ix in accordance with the information S such as the operation mode, specifically, the operation mode, the failure state, and the priority described later, calculates the direct current Idc_cal based on Expression (3) using the selected operation terms, and outputs this calculation result to the control device as the estimated direct current.

Note that the orientation in which the direct current and the alternating current flow into the motor is positive. In a case where the direct current is calculated using the ON time of the lower arm, the orientation in which the alternating current returns to the direct current power source 200 is positive, and therefore, since the orientation in which the direct current flows into the motor is positive, the direct current is calculated by multiplying by a negative number.

In a case where the direct current is estimated using the ON time of the upper arm, when the alternating current is positive, the direct current is calculated by, for example, Expression (4) with the duty Dx=(IGBT ON time)/PWM period, using the IGBT ON time illustrated in FIGS. 2 (B), 3(B), and 4 (B). When the alternating current is negative, the duty Dx=(Diode ON time)/PWM period, using the diode ON time illustrated in FIGS. 2(B), 3(B), and 4 (B).

$$Idc\_cal = Du * Iu + Dv * Iv + Dw * Iw \qquad ( 4 )$$

In a case where the direct current is estimated using the ON time of the lower arm, when the alternating current is positive, the direct current is calculated by, for example, Expression (5) with the duty Dx=(Diode ON time)/PWM period. When the alternating current is negative, the duty Dx=(IGBT ON time)/PWM period.

$$Idc\_cal = Du * ( - Iu ) + Dv * ( - Iv ) + Dw * ( - Iw ) \qquad ( 5 )$$

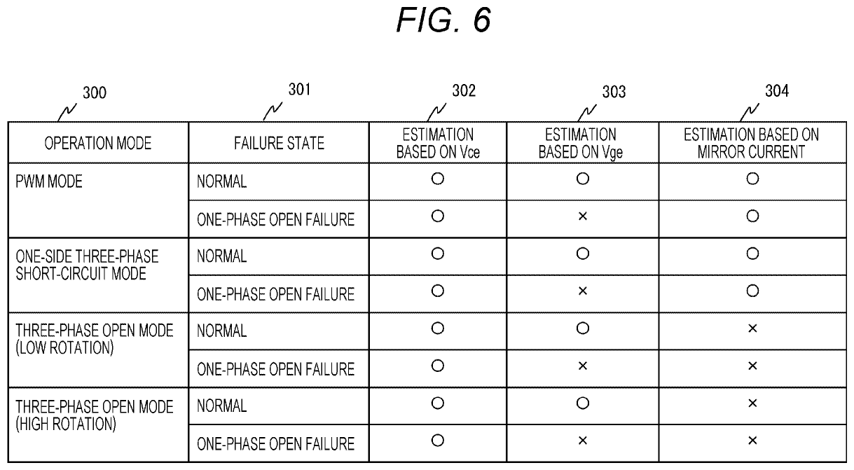

FIG. 6 is a table showing the relationship between the operation mode and estimation of direct current.

In the table shown in FIG. 6, column 300 indicates the operation mode, column 301 indicates the failure state, column 302 indicates the estimation of the direct current based on the Vce voltage, column 303 indicates the estimation of the direct current based on the Vge voltage, and column 304 indicates the estimation of the direct current based on the mirror current. In this table, a circle (o) is shown in a case where the estimation of direct current is suitable, and a cross (x) is shown when it is not suitable.

The operation mode includes the PWM mode, the one-side three-phase short-circuit mode, the three-phase opening mode when the motor rotates at a low speed, and the three-phase opening mode when the motor rotates at a high speed.

The PWM mode is a mode for driving the motor by controlling ON/OFF of the switching elements 10I and 11I of the upper arm and the lower arm based on the PWM signal. The one-side three-phase short-circuit mode is a mode for short-circuiting all the switching elements 10I and 11I of the three phases of the upper arm or the lower arm. The three-phase open mode is a mode for opening all the switching elements 10I and 11I of the three phases of the upper arm and the lower arm. For example, the one-side three-phase short-circuit mode or the three-phase open mode is designated in a vehicle standby state, a vehicle safety state at the time of vehicle failure, vehicle towing, and the like.

The PWM mode is a mode for power running or regenerating the motor by controlling ON/OFF of the switching elements 10I and 11I of the upper arm and the lower arm, respectively, by the PWM signal generated in response to the torque command. A dead time is provided between the ON time and the ON time so that the switching elements 10I and 11I of the upper arm and the lower arm are not short-circuited.

In the one-side three-phase short-circuit mode, the switching elements 10I of all the three phases of the upper arm are turned on. Alternatively, the switching elements 11I of all the three phases of the lower arm are turned on. For example, in the one-side three-phase short-circuit mode, it is desired to reduce the output torque in the vehicle safety state, but the output torque increases at low rotation. Also in such a case, estimation of the direct current is necessary.

In the three-phase open mode, the switching elements 10I and 11I of the upper arm and the lower arm are turned off for all the three phases. In the three-phase open mode, it is desired to reduce the output torque in the vehicle safety state, but the output torque increases at high rotation. For example, the direct current is about 0 A at the time of low rotation of the motor, but when the induced voltage becomes greater than the battery voltage of the direct current power source 200 at the time of high rotation of the motor, the current flows to the battery side via the diodes 10D and 11D, and the system may be destroyed. Also in such a case, estimation of the direct current is necessary.

The failure state is divided into normal and one-phase open failure for each operation mode. The one-phase open failure is a case where it is detected by a failure diagnosis that one phase of the switching elements 10I and 11I of the three phases of the upper arm and the lower arm is fixed in an OFF state. Normal is a case where no failure is detected by a failure diagnosis.

The estimation of direct current by the Vce voltage shown in column 302 of the table shown in FIG. 6 is applicable in all operation modes and failure states. The estimation of direct current by the Vge voltage shown in column 303 is applicable in all operation modes in a normal case free from failure. The one-phase open failure is excluded in the estimation of direct current by the Vge voltage is because the estimation is based on the voltage as a command value input to the gates of the switching elements 10I and 11I, and thus, the true value is not indicated when the switching elements 10I and 11I fail. The estimation of direct current by the mirror current shown in column 304 is applicable in the PWM mode and the one-side three-phase short-circuit mode regardless of the presence or absence of failure.

However, the estimation of direct current by the mirror current is applied when the alternating current is greater than a predetermined value.

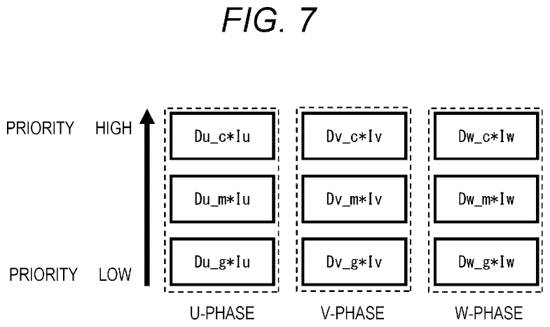

FIG. 7 is a table showing priority of operation terms of each phase.

The Vce operation term Dx_c*Ix, that is, the operation terms Du_c*Iu, Dv_c*Iv, and Dv_c*Iw of the respective phases are output from the Vce current estimation circuit 41, and these are the highest priority. The mirror current operation term Dx_m*Ix, that is, the operation terms Du_m*Iu, Dv_m*Iv, and Dv_m*Iw of the respective phases are output from the M current estimation circuit 42, and these are the next highest priority. The Vge operation term Dx_g*Ix, that is, the operation terms Du_g*Iu, Dv_g*Iv, and Dv_g*Iw of the respective phases are output from the Vge current estimation circuit 43, and these are the lowest priority. In the following description, a case of the priority shown in FIG. 7 will be described as an example, but other priority may be determined in accordance with the characteristics of the switching elements 10I and 11I, the diodes 10D and 11D, and the like.

The direct current determination circuit 44 stores the information shown in the table of FIG. 7 in a storage unit not illustrated. Then, an operation term is selected with reference to this priority and the information S that is input, the selected operation term is calculated by applying it to Expression (3), and the direct current Idc_cal to be finally output is estimated.

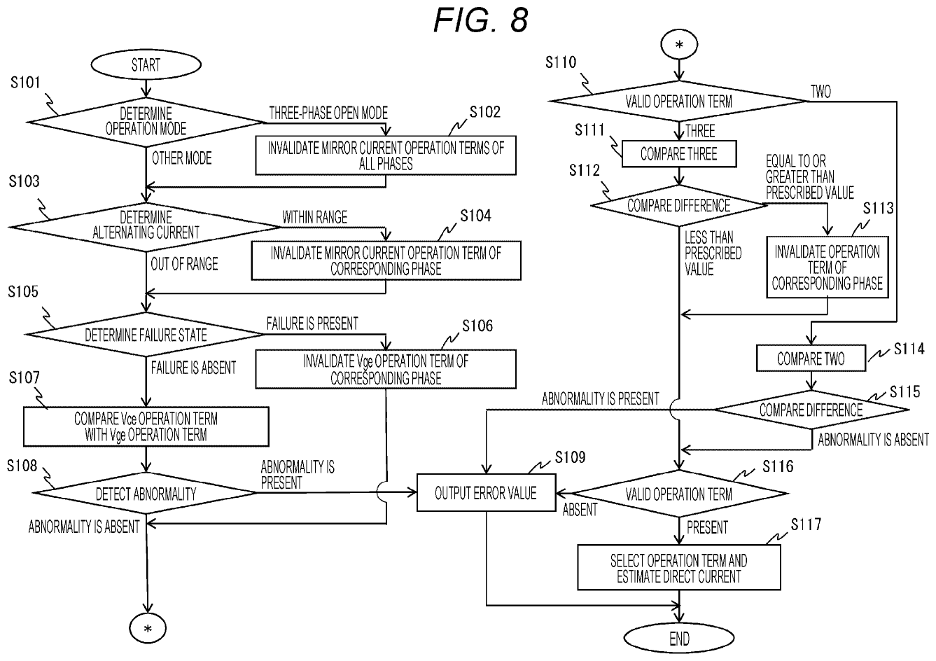

FIG. 8 is a flowchart showing the operation of estimation processing of direct current in the direct current determination circuit 44.

In step S101, the direct current determination circuit 44 determines the operation mode based on the information S that is input. Then, if in the three-phase open mode, the process proceeds to step S102. If in a mode other than the three-phase open mode, that is, the PWM mode or the one-side three-phase short-circuit mode, the process proceeds to step S103.

In step S102, the mirror current operation term Dx_m*Ix of all the phases is invalidated. This is because in the three-phase open mode, there are only current paths of the diodes 10D and 11D, and the M current estimation circuit 42 cannot measure the current flowing through the diodes 10D and 11D. After the processing of step S102, the process proceeds to step S103.

In step S103, the magnitudes of the alternating current Ix, that is, the alternating current Iu of the U-phase, the alternating current Iv of the V-phase, and the alternating current Iw of the W-phase are determined for each phase. If the alternating current Ix is within the mirror current disabled range in any phase, the process proceeds to step S104. If the alternating current Ix is not within the mirror current disabled range in all the phases, the process proceeds to step S105.

In step S104, the mirror current operation term Dx_m*Ix of the phase within the mirror current disabled range is invalidated. After the processing of step S104, the process proceeds to step S105.

In step S105, the direct current determination circuit 44 determines a failure state for each phase based on the information S that is input. Note that the failure states of the switching elements 10I and 11I are diagnosed by a failure diagnosis circuit not illustrated and input as the information S. When it is determined that there is a one-phase open failure in any phase of the switching elements 10I and 11I, the process proceeds to step S106. When it is determined that there is no one-phase open failure, the process proceeds to step S107.

In step S106, the Vge operation term Dx_g*Ix of the phase having the one-phase open failure is invalidated. Specifically, the operation term of the corresponding phase having the one-phase open failure among the operation terms Du_g*Iu, Dv_g*Iv, and Dv_g*Iw is invalidated. This is because the estimation of direct current by Vge does not show a true value in the one-phase open failure. After the processing of step S106, the process proceeds to step S110.

In step S107, the Vce operation term Dx_c*Ix and the Vge operation term Dx_g*Ix are calculated for each phase, their values are compared, and the process proceeds to step S108.

In step S108, when there is a large difference between the value of the Vce operation term Dx_c*Ix and the value of the Vge operation term Dx_g*Ix, it is detected as an abnormality of the Vce operation term. If there is an abnormality, the process proceeds to step S109. If there is no abnormality, the process proceeds to step S110. This is for the following reason. For example, when it is determined in the determination of step S105 that there is no one-phase open failure, the switching elements 10I and 11I are normal, and thus the Vge operation term is basically correct. However, the Vce operation term is prevented term from being erroneously selected when a circuit in the Vce current estimation circuit 41 has failed.

In step S109, the estimation of direct current is disabled, an error value is output to the control device, and the estimation processing of direct current ends.

In step S110, an effective operation term among the operation terms of the three, that is, the Vce operation term Dx_c*Ix, the mirror current operation term Dx_m*Ix, and the Vge operation term Dx_g*Ix is determined for each phase. When the operation terms of the three are valid, the process proceeds to step S111. When the operation terms of the two are valid, the process proceeds to step S114.

In step S111, the differences among the operation terms of the three are compared. For example, when the Vce operation term, the mirror current operation term, and the Vge operation term of each phase are 101 amperes (A), 99 amperes (A), and 150 amperes (A), respectively, relationships in the following Expressions (6), (7), and (8) are established.

$$\vert Vce operation term - mirror current operation term \vert = 2 A < threshold \qquad ( 6 )$$

$$\vert Mirror current operation term - Vge operation term \vert = 51 A \geq threshold \qquad ( 7 )$$

$$\vert Vge operation term - Vce operation term \vert = 49 A \geq threshold \qquad ( 8 )$$

Here, the threshold is a threshold for determination of difference comparison. This indicates that there is an abnormality in the Vge operation term. In this case, the Vge operation term is invalidated in subsequent step S113.

After the processing of step S111, the process proceeds to step S112. In step S112, when the difference of the operation terms is equal to or greater than a specified value, the process proceeds to step S113, and the operation term of the corresponding phase is invalidated. After the processing of step S113, the process proceeds to step S116. In step S112, also when the difference of the operation terms is smaller than the specified value, the process proceeds to step S116.

In step S114, the remaining two are compared. Then, in the next step S115, the differences between the operation terms of the two are compared. When the difference is equal to or greater than the specified value, the process proceeds to step S109. In a case where the difference is smaller than the specified value, the process proceeds to step S116.

In step S116, it is determined whether a valid operation term remains for each phase. If no valid operation term remains, the process proceeds to step S109. If a valid operation term remains, the process proceeds to step S117.

In step S117, the direct current determination circuit 44 selects an operation term with high priority for each phase from the remaining valid operation terms, applies the selected operation term to Expression (3), calculates the operation term, outputs this to the control device, and ends the estimation processing of direct current.

Note that the estimation processing of direct current by the direct current determination circuit 44 is designed so as to reduce an influence of delay in acquisition of the ON time, such as having the calculation cycle of the estimation processing within the PWM period.

The above estimation processing of direct current will be described below by condition.

### Condition 1: Steps S101 to S102

In the three-phase open mode, the mirror current operation terms of all phases are not used.

### Condition 2: Steps S103 to S104

In each phase, when the alternating current is small, the mirror current operation term is not used.

### Condition 3: Steps S105 to S106

In each phase, the Vge operation term is not used in the failure state of the switching elements 10I and 11I.

A valid operation term that does not fall under the above conditions 1 to 3 is used.

### Condition 4: Steps S110 to S113

The Vce operation term, the mirror current operation term, and the Vge operation term of each phase are compared with one another of the three, and an operation term in which the difference is equal to or greater than the specified value is not used. The comparison of the three is performed when the three are effective.

### Condition 5: Step S117

Among the valid operation terms that do not fall under the above conditions 1 to 4, an operation term with high priority is selected, and a final direct current is estimated.

### Condition 6: Steps S109 and S116

In the above conditions 1 to 4, when there is no operation term to be selected, an error value is output.

### Condition 7: Steps S108 and S109

When the switching elements 10I and 11I are not in the failure state, the Vce operation term is monitored, and in a case of an abnormality, the Vce operation term is not used.

Under the above conditions 1 to 7, among the remaining operation terms, an operation term with high priority is selected for each phase, and the direct current Idc_cal to be finally output is estimated. For example, in a case where the mirror current operation term Du_m*Iu has the highest priority in the U-phase, the Vce operation term Dv_c*Iv has the highest priority in the V-phase, and the Vce operation term Dw c*Iw has the highest priority in the W-phase, these operation terms are applied to Expression (3), and the direct current Idc_cal is calculated by the following Expression (9).

$$Idc\_cal = Du\_m * Iu + Dv\_c * Iv + Dw\_c * Iw \qquad ( 9 )$$

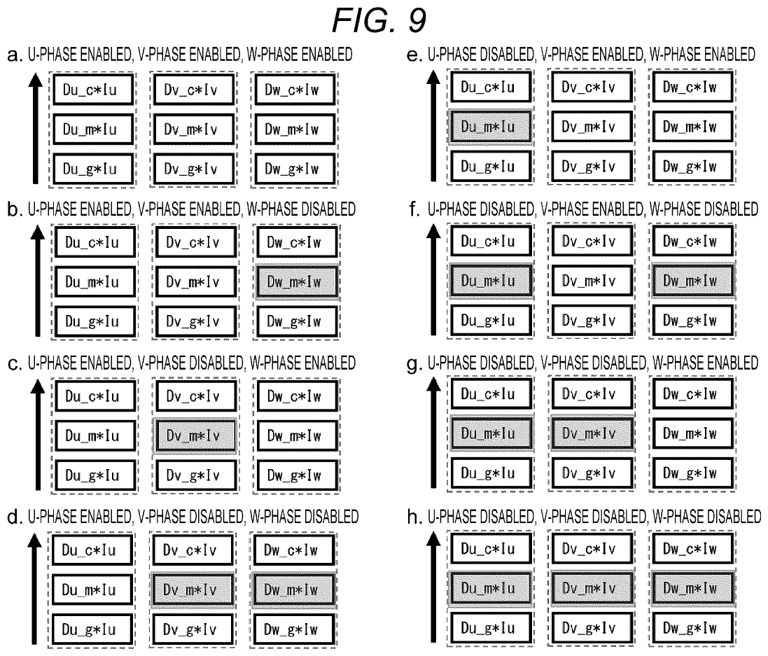

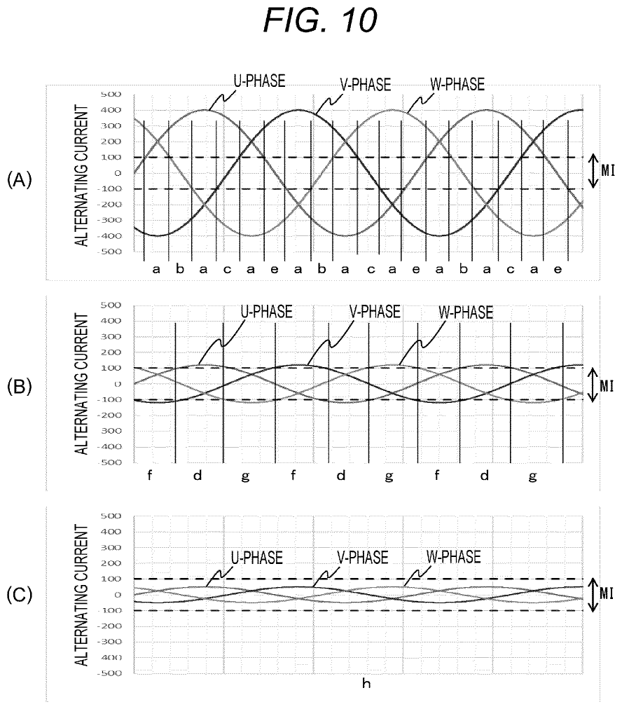

Next, a case of Condition 2 (in each phase of steps S103 and S104, when the alternating current is small, the mirror current operation term is not used) will be described as an example with reference to FIGS. 9 and 10.

FIGS. 9a to 9h are tables showing priorities including disabled mirror current operation terms in the U-phase, the V-phase, and the W-phase. In the drawing, the disabled mirror current operation terms are illustrated in gray.

FIG. 9a is a table showing priority in which the alternating current is not small and a disabled mirror current operation term is not included. In this case, it is possible to use the mirror current operation terms of the U-phase, the V-phase, and the W-phase, and it is possible to compare the operation terms of the three described in step S111 of FIG. 8.

FIG. 9b shows that the alternating current of the W-phase is small and the mirror current operation term of the W-phase is disabled.

FIG. 9c shows that the alternating current of the V-phase is small and the mirror current operation term of the V-phase is disabled.

FIG. 9d shows that the alternating currents of the V-phase and the W-phase are small, and the mirror current operation terms of the V-phase and the W-phase are disabled. FIG. 9e shows that the alternating current of the U-phase is small and the mirror current operation term of the U-phase is disabled.

FIG. 9f shows that the alternating currents of the U-phase and the W-phase are small, and the mirror current operation terms of the U-phase and the W-phase are disabled. FIG. 9g shows that the alternating currents of the U-phase and the V-phase are small, and the mirror current operation terms of the U-phase and the V-phase are disabled. FIG. 9h illustrates that the alternating currents of the U-phase, the V-phase, and the W-phase are small, and the mirror current operation terms of the U-phase, the V-phase, and the W-phase are disabled. In the state shown in FIGS. 9b to 9f, the comparison of the operation terms of the three described in step S111 of FIG. 8 is not performed.

FIGS. 10(A), 10(B), and 10(C) are views illustrating waveforms of alternating currents of the U-phase, the V-phase, and the W-phase. FIG. 10(A) illustrates an example of a case where the alternating current is large, FIG. 10(B) illustrates an example of a case where the alternating current is medium, and FIG. 10(C) illustrates an example of a case where the alternating current is small. Each figure illustrates a mirror current disabled range MI and an alternating current. Each figure illustrates a solid line that divides sections when the waveform of the alternating current of each phase enters the mirror current disabled range MI.

In FIG. 10(A), when the alternating currents of all the phases of the U-phase, the V-phase, and the W-phase do not fall within the mirror current disabled range MI, the estimation processing of direct current based on the table shown in FIG. 9a is performed. This section is indicated by a in the drawing.

In FIG. 10(A), when the alternating current of the W-phase falls within the mirror current disabled range MI, the estimation processing of direct current based on the table shown in FIG. 9b is performed. This section is indicated by b in FIG. 10 (A). In this section, the mirror current operation term of the W-phase is invalidated.

In FIG. 10(A), when the alternating current of the V-phase falls within the mirror current disabled range MI, the estimation processing of direct current based on the table shown in FIG. 9c is performed. This section is indicated by c in the drawing. In this section, the mirror current operation term of the V-phase is invalidated.

In FIG. 10(A), when the alternating current of the U-phase falls within the mirror current disabled range MI, the estimation processing of direct current based on the table shown in FIG. 9e is performed. This section is indicated by e in the drawing. In this section, the mirror current operation term of the U-phase is invalidated.

In FIG. 10(B), when the alternating currents of the U-phase and the W-phase fall within the mirror current disabled range MI, the estimation processing of direct current based on the table shown in FIG. 9f is performed. This section is indicated by f in the drawing. In this section, the mirror current operation terms of the U-phase and the W-phase are invalidated.

In FIG. 10(B), when the alternating currents of the V-phase and the W-phase fall within the mirror current disabled range MI, the estimation processing of direct current based on the table shown in FIG. 9d is performed. This section is indicated by d in the drawing. In this section, the mirror current operation terms of the V-phase and the W-phase are invalidated.

In FIG. 10(B), when the alternating currents of the U-phase and the V-phase fall within the mirror current disabled range MI, the estimation processing of direct current based on the table shown in FIG. 9g is performed. This section is indicated by g in the drawing. In this section, the mirror current operation terms of the U-phase and the V-phase are invalidated.

In FIG. 10(C), when the alternating currents of all of the U-phase, the V-phase, and the W-phase fall within the mirror current disabled range MI, the estimation processing of direct current based on the table shown in FIG. 9h is performed. In this case, the entire section is indicated by h in the drawing. In this section, the mirror current operation terms of the U-phase, the V-phase, and the W-phase are invalidated.

According to the first embodiment of the present invention, it is possible to eliminate the need for a direct current sensor, and accurately estimate a direct current. In the estimation of the direct current, the ON time based on the Vce voltage, the ON time based on the mirror current, and the ON time based on the Vge voltage are measured at the edges of the respective waveforms, thereby improving the accuracy. Furthermore, use of the estimation of direct current by the Vce voltage, the estimation of direct current by the mirror current, and the estimation of direct current by the Vge voltage in appropriate combination can improve availability and reliability.

### First Configuration Example

In the embodiment described above, the three of the estimation of direct current by the Vce voltage, the estimation of direct current by the mirror current, and the estimation of direct current by the Vge voltage are used in combination, but at least one of the estimation of the estimation of direct current by the Vce voltage, the estimation of direct current by the mirror current, and the estimation of direct current by the Vge voltage may be used.

In this case, the configuration includes a switch element inter-terminal voltage detection unit that detects an inter-terminal voltage of the switching element of each of the upper arm and the lower arm, and a direct current estimation unit that estimates a direct current flowing between the positive-side terminal and the negative-side terminal based on the inter-terminal voltage detected by the switch element inter-terminal voltage detection unit and the alternating current detected by the alternating current detection unit (alternating current sensor 30). The switch element inter-terminal voltage detection unit detects the Vce voltage or the Vge voltage of the switching element.

Specifically, the power conversion device 100 has a circuit configuration in which the configuration related to the estimation of direct current by the mirror current, such as the mirror current detectors 24 and 26 and the mirror current measurement circuits 25 and 27, are removed from the configuration illustrated in FIG. 1. The circuit configuration includes at least one of estimation of direct current by the Vce voltage and estimation of direct current by the Vge voltage. In this case, the Vce detectors 16 and 18, the Vce measurement circuits 17 and 19, the Vge detectors 20 and 22, and the Vge measurement circuits 21 and 23 may be provided corresponding to the switching element of either the upper arm or the lower arm, and may measure either the ON time of the upper arm or the ON time of the lower arm.

The estimation of direct current by the Vce voltage is applicable in all operation modes and failure states. The estimation of direct current by the Vge voltage is applicable in all operation modes in a normal case where there is no failure. Therefore, according to the estimation of direct current by any of these and according to the estimation of direct current by a combination thereof, it is possible to eliminate the need for a direct current sensor, and accurately estimate a direct current. In the estimation of the direct current, the ON time based on the Vce voltage and the ON time based on the Vge voltage are measured at the edges of the respective waveforms, thereby improving the accuracy. Furthermore, use of the estimation of direct current by the Vce voltage and the estimation of direct current by the Vge voltage in appropriate combination can improve availability and reliability.

### Second Configuration Example

In the embodiment described above, the three of the estimation of direct current by the Vce voltage, the estimation of direct current by the mirror current, and the estimation of direct current by the Vge voltage are used in combination, but only the estimation of direct current by the mirror current may be used.

In this case, the configuration includes a mirror current detection unit that detects a mirror current flowing through the a mirror element connected in parallel to each switching element of the switching elements of the upper arm and the lower arm, and a direct current estimation unit that estimates a direct current flowing between the positive-side terminal and the negative-side terminal based on the mirror current detected by the mirror current detection unit and the alternating current detected by the alternating current detection unit.

Specifically, the power conversion device 100 has a circuit configuration in which the configuration related to the estimation of direct current by the Vce voltage and the Vge voltage, such as the Vce detectors 16 and 18, the Vce measurement circuits 17 and 19, the Vge detectors 20 and 22, and the Vge measurement circuits 21 and 23, are removed from the configuration illustrated in FIG. 1. Since the mirror current cannot measure the current flowing through the diodes 10D and 11D, the mirror current detector 24, both the upper arm and the lower arm are provided with the mirror current measurement circuit 25, the mirror current detector 26, and the mirror current measurement circuit 27.

The estimation of direct current by the mirror current is applicable in the PWM mode and the one-side three-phase short-circuit mode regardless of the presence or absence of failure when the alternating current is greater than a predetermined value. Therefore, according to the estimation of direct current, it is possible to eliminate the need for a direct current sensor, and accurately estimate a direct current. In the estimation of the direct current, the ON time based on the mirror current is measured at the edges of the respective waveforms, thereby improving the accuracy.

Note that a configuration in which the configuration example 2 is added to the configuration example 1 may be adopted. Specifically, the configuration necessary for the estimation of direct current by the mirror current may be added to the configuration necessary for the estimation of direct current by the Vce voltage. Alternatively, the configuration necessary for the estimation of direct current by the mirror current may be added to the configuration necessary for the estimation of direct current by the Vge voltage. Use of them in combination for the estimation of direct current can improve availability and reliability.

In the embodiment described above, the operation of the estimation processing of direct current in the direct current determination circuit 44 has been described with reference to the flowchart of FIG. 8. The operation of the estimation processing of this direct current determination circuit 44 may be executed by a control device such as a microcomputer not illustrated. The flowchart shown in FIG. 8 describes processing performed by executing a program, but the program is executed by a processor (e.g., CPU, GPU) to perform predetermined processing appropriately using a storage resource (e.g., memory) and/or an interface device (e.g., communication port), and therefore, the subject of the processing may be the processor. Similarly, the subject of the processing performed by executing the program may be a controller having a processor, a device, a system, a computer, or a node. The subject of the processing performed by executing the program may be a calculation unit, and may include a dedicated circuit (e.g., FPGA or ASIC) that performs specific processing.

The program may be installed in a device such as a computer from a program source. The program source may be, for example, a program distribution server or a computer-readable storage medium. When the program source is a program distribution server, the program distribution server may include a processor and a storage resource that stores a distribution target program, and the processor of the program distribution server may distribute the distribution target program to another computer. In the following description, two or more programs may be implemented as one program, or one program may be implemented as two or more programs.

According to the embodiment described above, the following operational effects can be obtained.

(1) The power conversion device 100 includes: the switching element 10I of the upper arm and the switching element 11I of the lower arm connected in series between the positive-side terminal 201 and the negative-side terminal 202 of direct current; the alternating current detection unit (alternating current detection sensor 30) that detects the alternating current Ix derived from the connection point 203 between the switching element 10I of the upper arm and the switching element 11I of the lower arm; the switch element inter-terminal voltage detection unit (Vce detectors 16 and 18, Vce measurement circuits 17 and 19, Vge detectors 20 and 22, and Vge measurement circuits 21 and 23) that detects an inter-terminal voltage of any switching element of the switching elements 10I and 11I of the upper arm and the lower arm, and/or the mirror current detection unit (mirror current detectors 24 and 26, and mirror current measurement circuits 25 and 27) that detects a mirror current flowing through a mirror element connected in parallel to each of the switching elements 10I and 11I; and the direct current estimation unit 40 that estimates the direct current Idc_cal flowing between the positive-side terminal 201 and the negative-side terminal 202 based on the inter-terminal voltage (Vce voltage, Vge voltage) and/or the mirror current and the alternating current Ix. This can eliminate the need for a direct current sensor, and accurately estimate a direct current.

(2) The estimation method for direct current in the power conversion device 100 including the switching element 10I of the upper arm and the switching element 11I of the lower arm connected in series between the positive-side terminal 201 and the negative-side terminal 202 of direct current, the alternating current detection unit (alternating current detection sensor 30) that detects the alternating current Ix derived from the connection point 203 between the switching element 10I of the upper arm and the switching element 11I of the lower arm, and at least one of the collector-emitter voltage detection unit (Vce detectors 16, 18, Vce measurement circuits 17, 19) between the collector and the emitter of the switching elements 10I and 11I, the gate-emitter voltage detection unit (Vge detectors 20 and 22 and Vge measurement circuits 21 and 23) between the gate and the emitter of the switching elements 10I and 11I, and/or the mirror current detection unit (mirror current detectors 24 and 26, and mirror current measurement circuits 25 and 27) that detects a mirror current flowing through a mirror element connected in parallel to each of the switching elements 10I and 11I, the estimation method for direct current in the power conversion device 100, in which the direct current Idc_cal flowing between the positive-side terminal 201 and the negative-side terminal 202 is estimated based on an ON time of at least one of the collector-emitter voltage, the gate-emitter voltage, and the mirror current, and the alternating current Ix. This can eliminate the need for a direct current sensor, and accurately estimate a direct current.

The present invention is not limited to the above-described embodiment, and other forms conceivable within the scope of the technical idea of the present invention are also included within the scope of the present invention as long as the features of the present invention are not impaired. The above-described embodiment and the first and second configuration examples may be combined.

### REFERENCE SIGNS LIST

10 power module of upper arm
11 power module of lower arm
10I, 11I switching element
10D, 11D diode
10C, 11C current mirror circuit
16, 18 Vce detector
17, 19 Vce measurement circuit
20, 22 Vge detector
21, 23 Vge measurement circuit
24, 26 mirror current detector
25, 27 mirror current measurement circuit
30 alternating current sensor
40 direct current estimation unit
41 Vce current estimation circuit
42 M current estimation circuit
43 Vge estimation circuit
44 direct current determination circuit
100 power conversion device
200 direct current power source
201 positive-side terminal
202 negative-side terminal
203 intermediate connection point

1. A power conversion device, comprising:
a switching element of an upper arm and a switching element of a lower arm connected in series between a positive-side terminal and a negative-side terminal of direct current;
an alternating current detection unit that detects an alternating current derived from a connection point between the switching element of the upper arm and the switching element of the lower arm;
a switch element inter-terminal voltage detection unit that detects an inter-terminal voltage of any switching element of the switching elements of the upper arm and the lower arm, and/or a mirror current detection unit that detects a mirror current flowing through a mirror element connected in parallel to each of the switching elements; and
a direct current estimation unit that estimates a direct current flowing between the positive-side terminal and the negative-side terminal based on the inter-terminal voltage and/or the mirror current and the alternating current.

2. The power conversion device according to claim 1, wherein the switch element inter-terminal voltage detection unit detects a collector-emitter voltage between a collector and an emitter of the switching element.

3. The power conversion device according to claim 2, wherein the direct current estimation unit measures an ON time of the switching element based on the collector-emitter voltage, and estimates the direct current based on the measured ON time and the alternating current.

4. The power conversion device according to claim 1, wherein the switch element inter-terminal voltage detection unit detects a gate-emitter voltage between a gate and an emitter of the switching element.

5. The power conversion device according to claim 4, wherein the direct current estimation unit measures an ON time of the switching element based on the gate-emitter voltage, and estimates the direct current based on the measured ON time and the alternating current when the switching element is free from failure.

6. The power conversion device according to claim 1, wherein the direct current estimation unit measures the ON time of the switching element based on the mirror current, and estimates the direct current based on the measured ON time, the mirror current, and the alternating current when the alternating current is greater than a predetermined value.

7. The power conversion device according to claim 3, wherein
three phases are configured by connecting in parallel conversion units for one phase configured by connecting in series the switching element of the upper arm and the switching element of the lower arm, and
the direct current estimation unit estimates the direct current in accordance with an operation mode of the switching elements of the upper arm and the lower arm.

8. The power conversion device according to claim 7, wherein the operation mode is a PWM mode in which a motor is driven by controlling ON/OFF of each of the switching elements of the upper arm and the lower arm, a one-side three-phase short-circuit mode in which all switching elements of three phases of the upper arm or the lower arm are short-circuited, or a three-phase open mode in which all switching elements of three phases of the upper arm or the lower arm are opened.

9. The power conversion device according to claim 1, wherein
the switch element inter-terminal voltage detection unit detects a collector-emitter voltage between a collector and an emitter of the switching element and/or a gate-emitter voltage between a gate and an emitter of the switching element, and
the direct current estimation unit that estimates a direct current flowing between the positive-side terminal and the negative-side terminal based on at least one of the collector-emitter voltage, the gate-emitter voltage, and the mirror current, and the alternating current.

10. The power conversion device according to claim 9, wherein
three phases are configured by connecting in parallel conversion units for one phase configured by connecting in series the switching element of the upper arm and the switching element of the lower arm, and
the direct current estimation unit performs no estimation based on the mirror current in a three-phase open mode in which all switching elements of three phases of the upper arm and the lower arm are opened.

11. The power conversion device according to claim 9, wherein the direct current estimation unit includes priority as to which of estimation based on the collector-emitter voltage, estimation based on the gate-emitter voltage, and estimation based on the mirror current to prioritize, and estimates the direct current in accordance with the priority.

12. The power conversion device according to claim 11, wherein
three phases are configured by connecting in parallel conversion units for one phase configured by connecting in series the switching element of the upper arm and the switching element of the lower arm, and
the priority is set for each phase of the three phases.

13. The power conversion device according to claim 11, wherein the priority is estimation based on the collector-emitter voltage, estimation based on the gate-emitter voltage, and estimation based on the mirror current in descending order of priority.

14. An estimation method for direct current in a power conversion device including
a switching element of an upper arm and a switching element of a lower arm connected in series between a positive-side terminal and a negative-side terminal of direct current,
an alternating current detection unit that detects an alternating current derived from a connection point between the switching element of the upper arm and the switching element of the lower arm, and
at least one of a collector-emitter voltage detection unit between a collector and an emitter of the switching element, a gate-emitter voltage detection unit between a gate and an emitter of the switching element, and/or a mirror current detection unit that detects a mirror current flowing through a mirror element connected in parallel to each of the switching elements, the estimation method for direct current in a power conversion device, wherein
a direct current flowing between the positive-side terminal and the negative-side terminal is estimated based on an ON time of at least one of the collector-emitter voltage, the gate-emitter voltage, and the mirror current, and the alternating current.
